(19) United States
(12) Patent Application Publication
(10) Pub. No.: US 2022/0212338 A1
(43) Pub. Date: Jul. 7, 2022

(54) NON-MOTORIZED PHYSICAL-ASSISTANCE DEVICE OF EXOSKELETON TYPE FOR MANUALLY TRANSPORTING LOADS

(71) Applicants: FM FRANCE SAS, PHALSBOURG (FR); UNIVERSITÉ DE TECHNOLOGIE DE COMPIÈGNE, COMPIÉGNE (FR); CENTRE NATIONAL DE LA RECHERCHE SCIENTIFIQUE, PARIS CEDEX 16 (FR)

(72) Inventor: KHALIL BEN MANSOUR, COMPIÈGNE (FR)

(21) Appl. No.: 17/607,591

(22) PCT Filed: Apr. 30, 2020
(86) PCT No.: PCT/EP2020/062098

§ 371 Date: Oct. 29, 2021

(30) Foreign Application Priority Data
May 3, 2019 (FR) 19 04661

(51) Int. Cl. B25J 9/00

(52) U.S. Cl. CPC B25J 9/0006; A61H 2201/165

(57) ABSTRACT

A non-robotic/non-motorized physical-assistance device of exoskeleton type, designed to be worn by a user to lighten the weight on the upper limbs of the user manually lifting and transporting a load. The device includes at least a hip belt configured to pass around the waist/hips of the user and a load lifter and transporter. When the device is worn by the user and in use, the load lifter and transporter includes a transfer member to transfer vertical loads brought about by the lifting/transporting of the load exclusively to the hip belt, relieving the load on the back, the upper limbs, the shoulders and the neck of the user.

### TECHNICAL FIELD OF THE INVENTION

The present invention relates to a non-robotic/non-motorized physical-assistance device of exoskeleton type for the manual transport of loads. It applies, in particular to the transport of packages by order preparers in handling warehouses.

### BACKGROUND OF THE INVENTION

Operators working in handling warehouses are subjected to substantial constraints and to working conditions that are sometimes difficult because they lift and transport all throughout the day loads that are more or less heavy, over more or less great distances, making movements that are more or less ergonomic and adapted to their morphology.

Many assistance devices have been created for several decades to improve these working conditions and lightens the load on the user during operations when they lift, transport and set down the lifted load. Among these devices are an entire series of exoskeletons that use various mechanical means, or robotic means that in particular make us of cylinders.

These physical-assistance devices or these physical-assistance robots are described in particular in patents FR3046038A1, FR3046052A1, FR3065387A1, FR2993811A1 or EP3189945B1. Simpler systems such as CORFOR® also allow for assistance by using elastic straps connecting the shoulders below the knees and the calves.

All these devices have different disadvantages among which the high weight, the lack of ergonomics and the low adaptability to the morphology of the users, the complex and fragile design, the low autonomy (for motorized systems and/or with assistance by cylinders), the hardly practical use (time needs to equip oneself), the lack of fluidity and of freedom of movement, the transfer of the weight of the package onto the shoulders and the back, the compression of the rib cage, the low efficiency and the high cost.

### OBJECT AND SUMMARY OF THE INVENTION

The present invention aims to overcome these disadvantages with an entirely innovative approach.

To this effect, according to a first aspect, the present invention relates to a non-motorized physical-assistance device of exoskeleton type, designed to be worn by a user in order, in use, to lighten the load on the upper limbs of said user manually lifting and transporting a load, said device comprising in particular a hip belt able to pass around the waist/hips of the user and load lifting/transporting assistance means, the device being worn by the user and being in use, the load lifting/transporting assistance means comprise a member for transferring, exclusively to the hip belt, vertical loads brought about by the load lifted/transported by the user, relieving the load on the back, the upper limbs, the shoulders and the neck of said user latter, characterized in that the member for transferring loads is constituted by a rigid dorsal support comprising a single central column being divided into two lateral branches passing over the shoulders of the user, without contact with the latter or the arms of the latter, and in that said lateral branches are erected perpendicularly to the central column and are projected forward on either side of the neck of the user.

This solution allows a user wearing the assistance device in accordance with the present invention, which is devoid of motorized or robotic means such as cylinders, to lift and transport with their hands loads of several kilograms, even several tens of kilograms, by feeling only an extremely low weight on the back and the upper limbs thanks to the transfer of the latter onto their hips and son pelvis, much more adapted for this.

Thus, not only is the assistance not carried out via a heavy robotic/motorized device, that is large and/or complex to manufacture and operate, but the load lifted appears light without the weight of the latter being supported by the shoulders or the back of the user.

Contrary to the existing solutions, this device makes it possible to assist with the carrying of a load in an industrial environment by reducing the forces generated by the weight of the package at the upper limbs and at the back. However, these forces are the cause of 50% of work stoppages. This device thus makes it possible to maintain the level of productivity while still preventing the appearance of MSD.

Finally, using a single central column substantially aligned with the vertebral column of the user and being divided into two lateral branches each one passing over its shoulders makes it possible to have natural and fluid movements without risking being hindered by the device, in particular at the neck, head and arms.

Providing a structure with the lateral branches that does not extend (or extremely little) in front of the body (shoulders, torso) of the user makes it possible to obtain a very light device, of very small size and very well balanced (right/left and front/rear).

Also note that the device is not in contact/does not support the humerus and/or the elbows and/or the forearms of the user, which here again allows for very great mobility and flexibility in use and prevents discomfort in use and/or pain.

The invention is implemented according to the embodiments and the alternatives disclosed hereinafter, which are to be considered individually or according to any technically permissible combination:
the two lateral branches are vertically separated from the shoulders of the user by a distance comprised between about 2 and 20 centimeters, preferably between substantially 5 and 15 centimeters, which on the one hand allows the user to lift their arms rather high without coming into contact with the branches, and which on the other hand prevents any transfer of the load on their shoulders or their neck thanks to the separation of said branches;
the lateral branches are adjustable in height and/or in rotation with respect to the central column, which makes it possible to adapt to different morphologies or methods of use;
the central column is adjustable in height at least at an upper portion in such a way as to adapt to different user sizes and improves comfort of use;
the member for transferring loads further includes manually extendible/retractable streamlined means to change the length of it, said streamlined means being disposed at least along the lateral branches of the column, which allows the user to manipulate the load carried as best as possible and manage the lifting/transporting assistance of the latter;
the streamlined means are wires, cables, cords or straps, which forms a light solution that is easy to design and to use;
the lateral branches of the member for transferring loads are constituted of hollow tubes and are passed through at least partially by the streamlined means, which allows for perfect integration of all the means implemented (masking of the streamlined means) in order to make the device compact, light and practical to use;
the streamlined means each pass through a guide provided with means for reducing friction, which guarantees fluid and effective movements during the lifting and the transporting of loads, and a reduction in the wear of the means used for this effect;
the means for reducing friction are constituted by an internal coating made of polytetrafluoroethylene (PTFE), such as TEFLON®, locally covering the inside of the hollow tubes of the lateral branches;
each streamlined means is connected to a winder/unwinder engaged with the central column and allowing, in use, said streamlined means to elongate/retract itself automatically in order to change length, which allows for an optimization of the load lifting and transporting operations according to the morphology (arm) of the user because the streamlined means fluidly and rapidly constantly accompany their own movements of the hands/arms/shoulders;
the streamlined means are each provided, at a free end, with a manual gripping means of the sleeve type, in such a way that the hands of the user are constantly connected to said streamlined means during the use of the device;
the device is provided, close to at least one of the handles, with a manual brake disengageable by the user to block/unblock the length of said streamlined means, which facilitates the load lifting and transporting operations because the operator very simply and intuitively controls the assistance provided by the device by blocking the streamlined means when they desire to do so;
the central column includes a hinge pin in a zone close to the connection with the hip belt in order to follow the inclination of the back of the user with respect to its lower limbs, which allows the user great freedom of movement, in particular to lift/set down loads that are positioned relatively low;
an elastic return element connects the hip belt to a lower portion of the central column, which procures additional assistance to the user, in particular when the latter has to pass from a position curved towards the front to a straight position;
the central column is provided with at least a back cushion, which improves the comfort of use of the device;
the device also includes shoulder straps for the transport thereof by the user, which allows for a good maintaining of the device on the back of the user when the latter is using it for their handling operations; and
the device further includes extendible elastic means connecting the hip belt to the knees of the user, this in order in particular to assist them when they pass from a squat position to a standing position.

### BRIEF DESCRIPTION OF THE DRAWINGS

Other advantages, purposes and characteristics of the present invention shall appear in the following description given, for the purposes of explanation and in no way limiting, with respect to the accompanying drawings, wherein:

FIG. 1 is a perspective isometric rear view of a device in accordance with the present invention worn by a user,

FIG. 2 is a perspective isometric front view of the device of FIG. 1;

FIG. 3 is a front view of FIG. 2;

FIG. 4 is a back view of FIG. 2;

FIG. 5 is a top view of FIG. 2;

FIG. 6 is a side view of FIG. 2;

FIG. 7 is a detailed view of a top portion of FIGS. 2 to 6;

FIG. 8 is a detailed view of FIG. 3;

FIG. 9 is a detailed view of a brake of the device in a first position; and

FIG. 10 is a view similar to FIG. 9 with the brake in a second position.

### DETAILED DESCRIPTION OF EMBODIMENTS

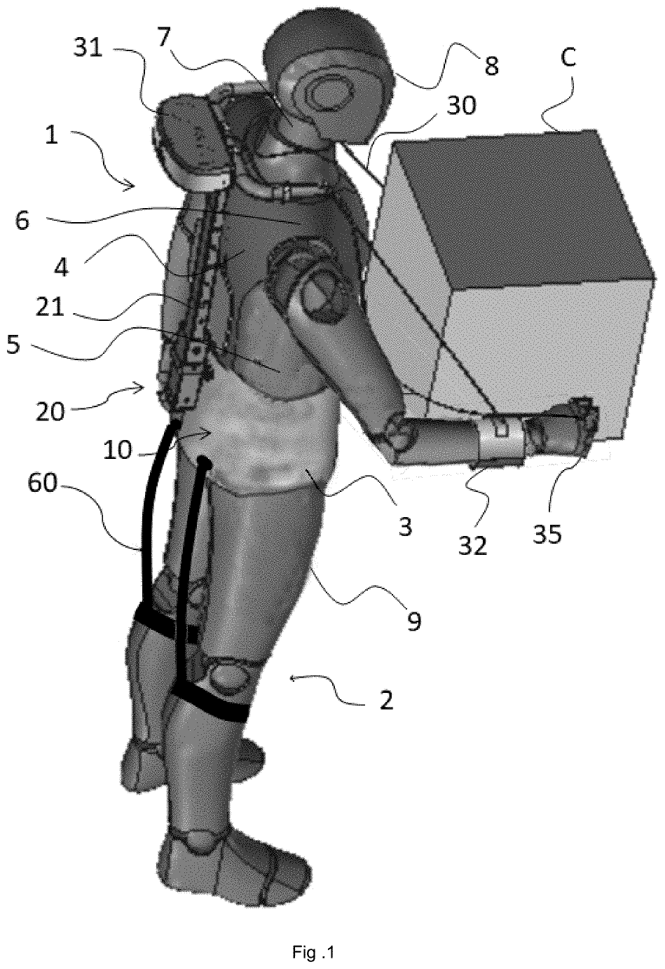

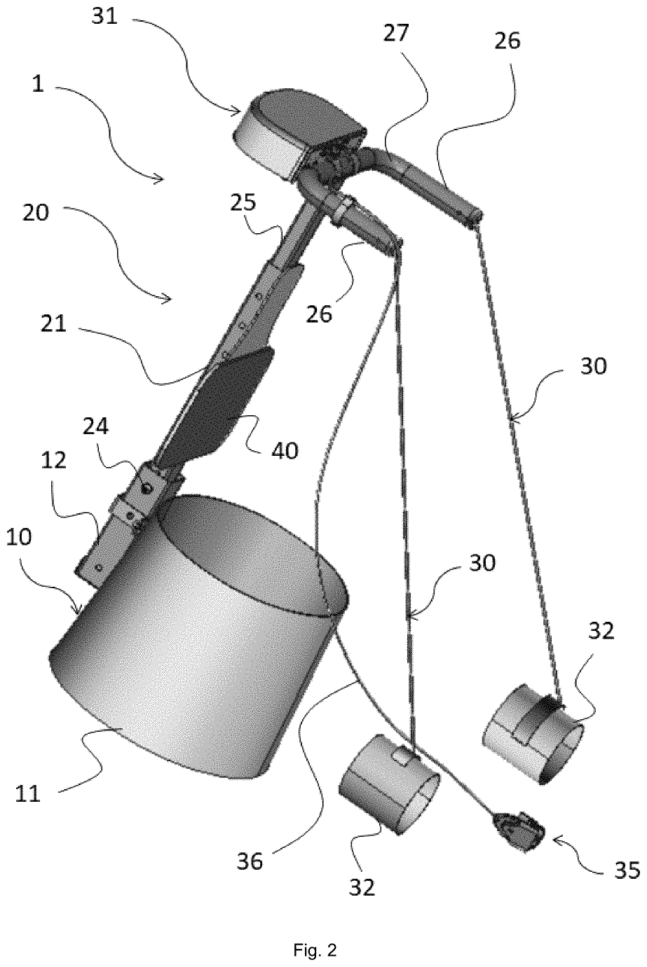

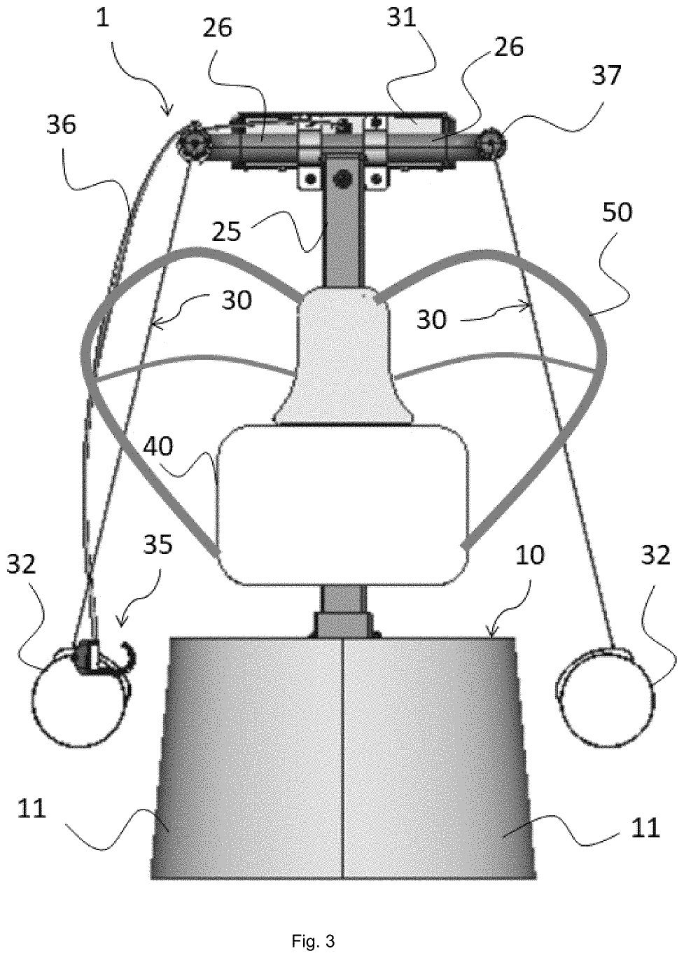

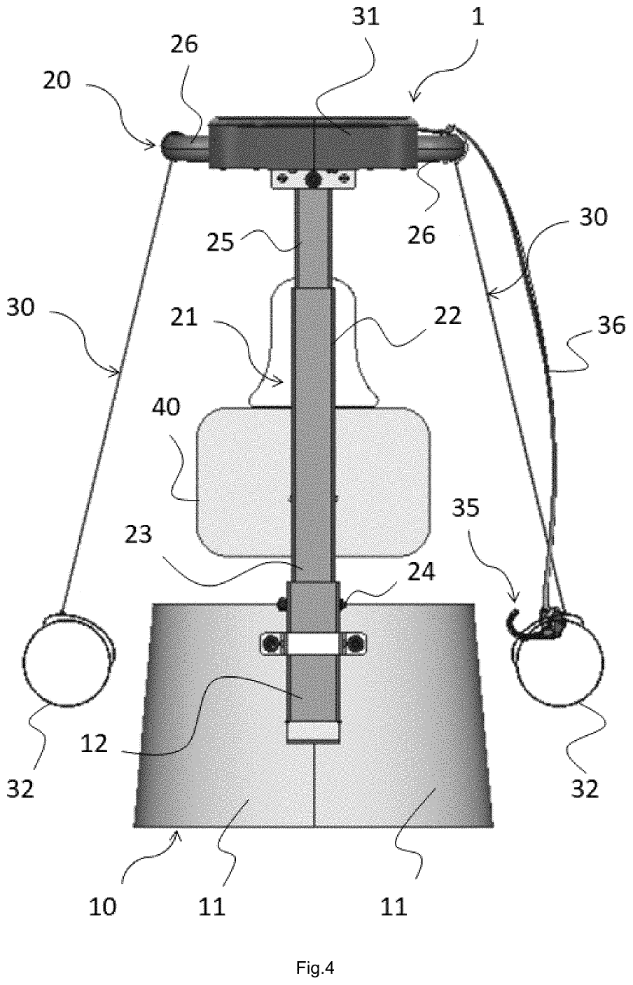

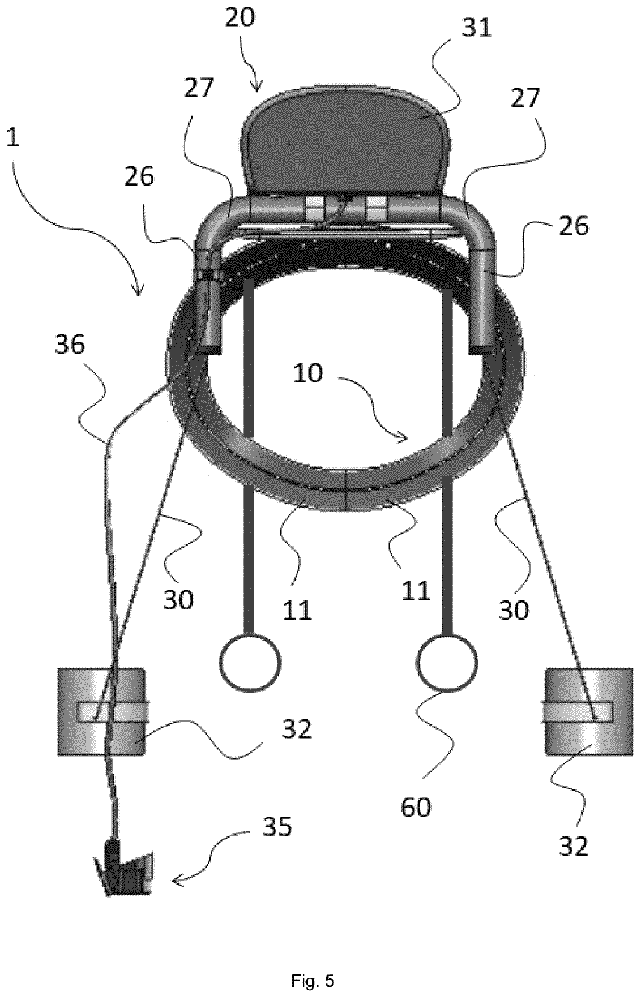

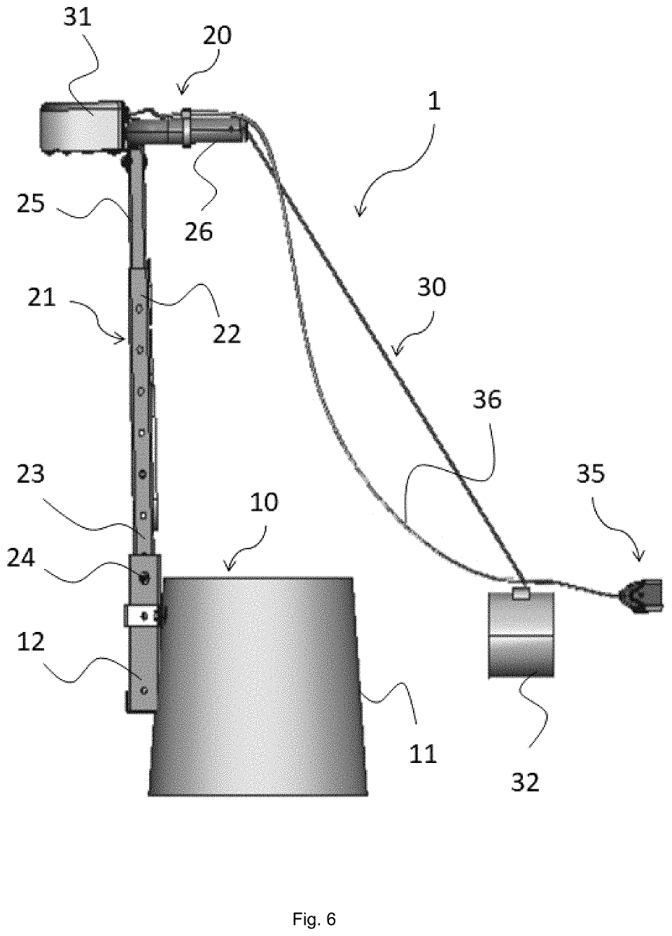

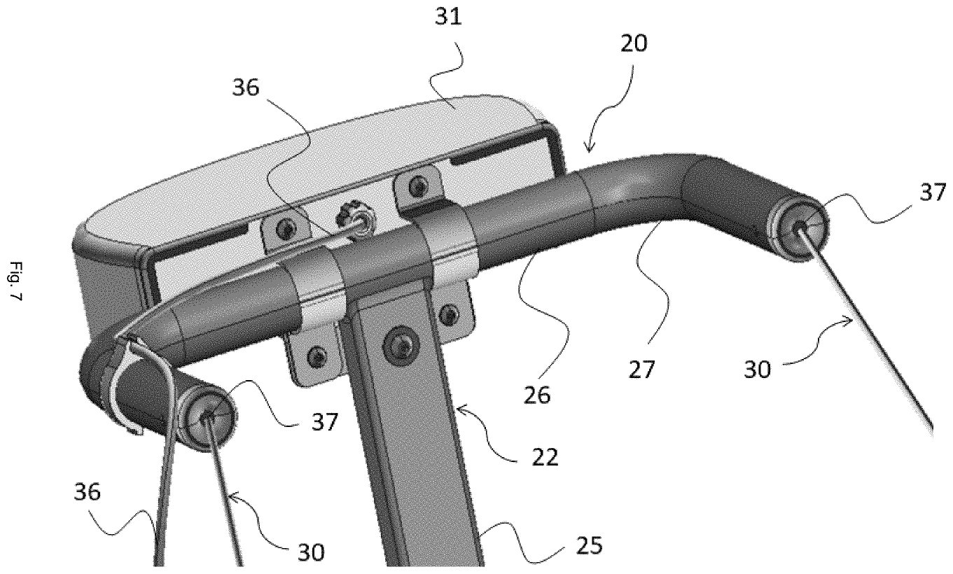

FIGS. 1 to 10 show a non-robotic/non-motorized physical-assistance device 1 of exoskeleton type designed to be worn by a user 2 in a delivery warehouse, for example an order preparer or a handler, in order to lighten the load, in use, on their upper limbs 5 when they are lifting and transporting a load C such as a package. The user 2 such as diagramed includes hips 3, a back 4, upper limbs 5, shoulders 6, a neck 7, a head 8 and lower limbs 9.

This physical-assistance device 1 mainly includes, in accordance with the present invention, a hip belt 10 at the rear of which are fastened load lifting/transporting assistance means 20.

More precisely, the hip belt 10 is intended for being tightened around the waist/hips 3 of the user 2. It includes for this adjustable straps 11 and a rear plate 12 intended for supporting the load lifting/transporting assistance means 20.

The load transport assistance means 20 include a member for transferring loads constituted by a rigid dorsal support 21 erected vertically from the hip belt 10.

More precisely, the rigid dorsal support 21 includes a central column (or mast/pole) 22 divided into a first small low portion 23 fastened to the plate 12, an intermediate hinge 24 and a second large top portion 25 running along the back 4 of the user. The intermediate hinge 24 allows in particular the central column 22 to be inclined by following the movements of the user 2, in particular by adapting the angle formed between their back 4 and their lower limbs 9 when they lean over or stand up.

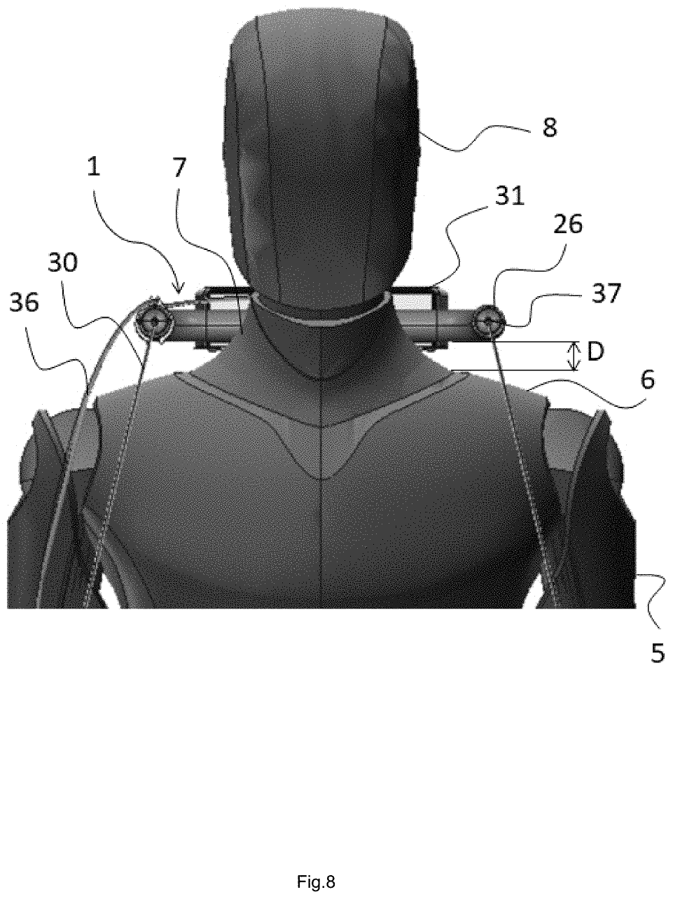

The top portion 25 of the central column 22 is extended by two lateral branches 26 moving away from said top portion 25 on either side of the neck 7 of the user 2 (see FIG. 8 for example).

Advantageously, the two branches 26 have a curvature 27 and pass over the shoulders 6 of the user 2, without being in contact with the latter. Typically, the lateral branches 26 of the dorsal support 21 are disposed, in use, at a distance D from the shoulders 6 of the user 2 comprised between a few centimeters and a few tens of centimeters, preferably between about 2 and 20 centimeters and advantageously between substantially 5 and 15 centimeters. These branches are also sufficiently separated from the neck 7 and from the head 8 of the user 2 to not hinder the latter in their movements.

The lateral branches 26 can be adjusted in height and in rotation around the top portion 25 of the central column 22 in order to adapt to the different morphologies and/or preferred methods of use (some users may prefer that the branches 26 be more or less separated from their shoulders 6 and/or from their neck 7 and/or from their head 8). The top portion 25 of the central column 22 can also be adjusted in height.

The lateral branches 26 are constituted of hollow tubes in order to allow for receiving manually extendible/retractable streamlined means 30 to change the length of it of which the use will be described hereinafter. All the portions that form the dorsal support 21 can be hollow so as to reduce the weight of the device. The hollow tubes of the dorsal support are for example made from steel, carbon fiber or composite materials.

The manually extendible/retractable streamlined means 30 to change the length of it are constituted in the present case by two cables disposed inside hollow tubes of the lateral branches 26, which then form a guide and are advantageously lined for this purpose with a means for reducing friction 37 such as a layer of PTFE, such as TEFLON®.

Each cable 30 is connected to a winder/unwinder 31 mounted in a common box engaged with the central column 22, more specifically the top portion 25. These two winders 31 allow, in use, said streamlined means 30 to be extended/retracted to change length. In addition, each cable 30 is provided at its free end with a sleeve 32 intended for being worn around the wrists of the user 2 and allowing the latter to lengthen/shorten said cables 30 while carrying a package C.

Each winder 31 is of the “pet leash/vacuum cleaner cable winder” type and is presented as a helical spring system which makes it possible to create a continuous traction force on the cable 30 considered so as to oppose the extending of the latter when the user 2 pulls on a sleeve 32.

The device 1 is moreover provided close to one of the sleeves 32, with a manual brake 35 disengageable by the user 2 to block/unblock cables 30 by directly acting on the winders 31.

An elastic return element (not shown) connects the hip belt 10 to the lower portion 23 of the central column 22 in order to facilitate passing from the inclined position to the straight position of the user 2.

The median portion 25 of the central column 22 is moreover provided with a cushion 40 intended for making the wearing of the device 1 more comfortable for the user 2. Advantageously this cushion 40 is placed lower than the winders 31, close to the lumbar hollow.

The device 1 also includes shoulder straps 50 to facilitate the transport thereof and prevent it from moving or falling during use.

Finally, the device 1 includes extendible elastic means 60 connecting the hip belt 10 to the lower limbs 9 of the user 2, for example their knees, so as to facilitate passing from the folded leg position to the straight leg position (case where the user 2 squats to grasp a package and stands up to transport it or to place it on a shelf).

Using the device 1 in accordance with the present invention is particularly simple.

Once worn on the back of the user 2 using adjustable straps 50 and once the hip belt 10 tightened and adjusted around hips 3, it is sufficient for the user 2 to grasp a package C with their two hands, after having installed the sleeves 32 around their wrists and grasped the brake 35.

The movements of the arms 5 and of the shoulders 6 of the user 2 are constantly accompanied by the lengthening or the shortening of the cables 30 because the latter are indirectly connected to the package C via hands and sleeves 32. Thus, if the user 2 folds their arms at their shoulders to raise the package (by remaining standing without folding the torso), the cables 30 will be shortened thanks to the traction force exerted by the winders 31. Inversely, if the user 2 unfolds their arms (for example to grasp a package positioned on the floor), the cables 30 will automatically be extended against the traction force exerted by the winders 31.

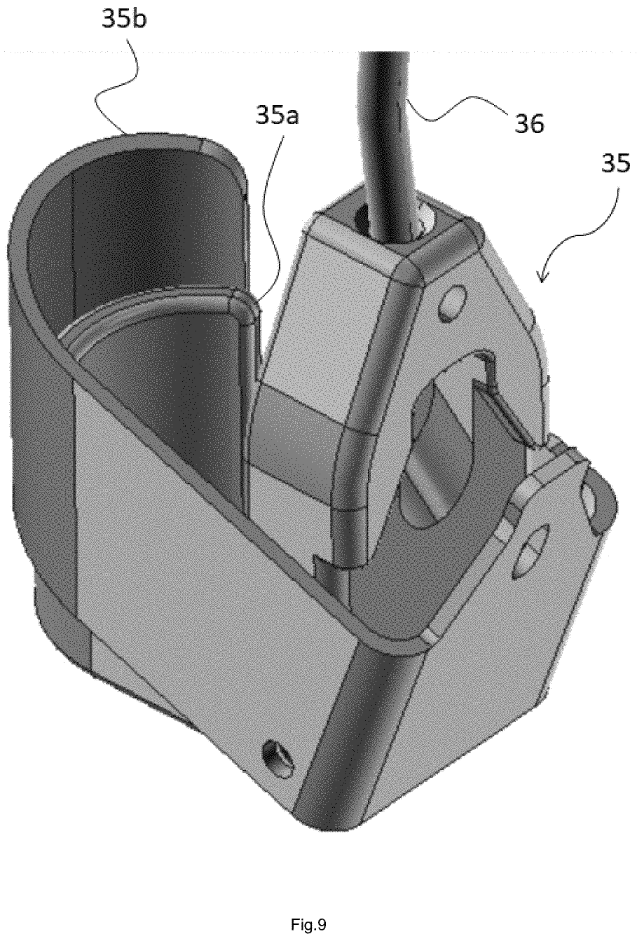

In the normal position of use, the brake 35 is deactivated (FIG. 9), i.e., it does not block the winder 31 and therefore the length of the cables 30, which therefore perfectly follow the movements of the arms 5 of the user 2 and (lengthening/shortening) according to these movements.

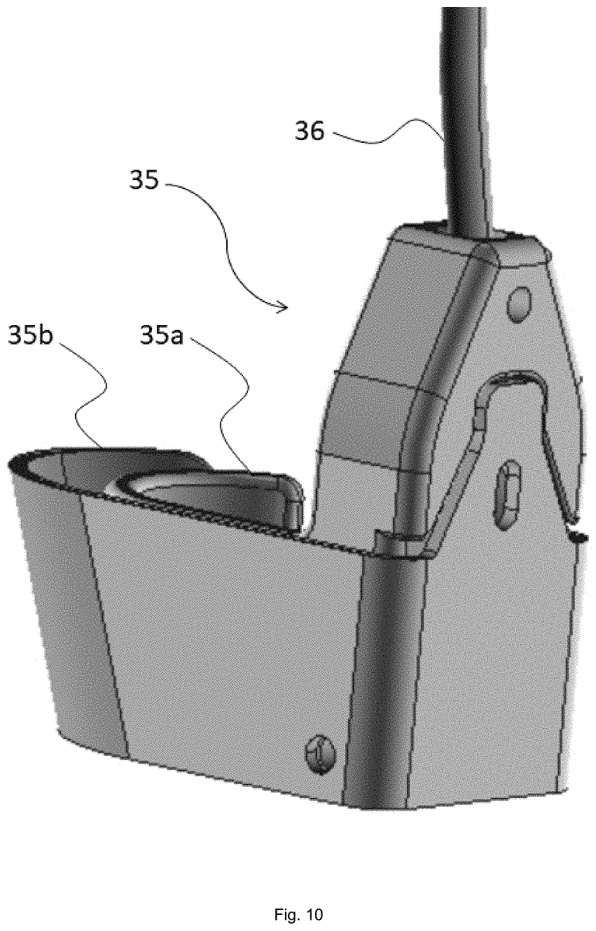

When the user 2 feels that they have correctly grasped the package and at a distance from the floor that is suitable for the transport thereof, they manually block the brake 35 by releasing it (FIG. 10), which has for effect to stop the lengthening or the shortening of the cables 30 because the winders 31 are blocked in their position.

In this position, the user 2 only has to hold the package C with their hands in order to prevent it from sliding/falling on the floor, without having to support its weight with their arms 5 and their shoulders 6, the cables 30 take up this force linked to the weight of the package C. This fore is in turn transferred onto the hollow tubes of the lateral branches 26 and on the winders 31 connected to the column 22, then on the hip belt 10 via the member for transferring loads constituted by the rigid dorsal support 21.

As the lateral branches 26 of the dorsal support 21 are never in contact with the shoulders 6, the neck 7 or the upper limbs 5 of the user 2 (see FIG. 8 in particular), the weight of the package C cannot rest on these parts of the human body because it is the cables 30 that take up the relay, in collaboration with the rigid branches 26, the winders 31 and the column 22. However, as the latter, just as the lateral branches 26 and the winders 31, is fastened to the hip belt 10, it is in reality mostly the latter that supports all the weight of the package thanks to chain of the transfer of forces described hereinabove. The vertebral column of the user 2 is also not solicited because the forces do not pass through the latter. The shoulders and the vertebral column of the user 2 support only a very small portion of the device 1 (most of its own weight being supported by the hip belt 10).

The user 2 can therefore transport the package C easily, without having to support the weight of the latter with their hands, their arms or their shoulders. They must simply hold the package C with their hands in order to prevent it from sliding or falling and ensure that the cables 30 remain correctly taught for the support. The sleeves 32 do not hinder this operation because they are well attached to the wrists of the user 2.

Once the package C is placed at the desired location, the user 2 only has to release the brake 35 by acting on it in order to unblock the winders 31.

This physical-assistance device 1 thus has an assistance in carrying a load C and therefore constitutes a tool for preventing the risks of musculoskeletal disorders which cause the degradation in the health of workers and generate work stoppages that penalize companies.

The solution proposed can be adapted to the morphology of many users 2 thanks to the different adjustments that it proposes (central column 22, straps of the hip belt 10, straps 50, branches 26). It is capable of lightening the load both on the upper limbs 5, the shoulders 6 and the back 4 of the user during load carrying tasks. The lessening of the forces lightens the load on the body at the arms and the back, thanks to a transfer of weight onto the hip belt 10. The dorsal support also improves the awareness of the user as to their posture. In its current form, the weight of this assistance prototype is about a kilogram and it is put on in a few seconds. This is therefore a piece of equipment that is extremely light and very intuitive to use.

The transfer of weight of the package C directly at the lumbar region makes it possible to reduce the lever effect of the lifting force of the package, which makes it possible to save the muscular forces at the upper limbs and at the back.

The device presented here is therefore distinguished from the existing solutions by the following points and advantages:
No additional weight is supported by the shoulders and the back;
No compression at the rib cage;
No motorization and pistons;
No movements imposed by the device;
Direct transfer of the weight to the pelvis;
No joint stress; and
The hands are free of any sizeable and uncomfortable instrumentation.

It must indeed be understood that the detailed description of the object of the invention, given only for the purposes of illustration, does not constitute in any way a limitation, with the technical equivalents also being comprised within the scope of the present invention.

Thus, the cables can be replaced with straps, cords or wires.

The form of the branches can vary as long as they comply with the imposed distance constraints with regards to the shoulders/neck/head of the user.

Other adjustments can be provided to best adapt the device 1 to the morphology of the users 2.

1-17. (canceled)

18. A non-motorized physical-assistance device of exoskeleton type, configured to be worn by a user to lighten a weight on upper limbs of the user manually lifting and transporting a load, the device comprising a hip belt configured to pass around a waist or hips of the user and a load lifter and transporter, the load lifter and transporter comprising a transfer member to transfer, exclusively to the hip belt, vertical loads brought about by the load lifted and transported by the user, relieving the weight on a back, the upper limbs, shoulders and a neck of the user; wherein the transfer member is constituted by a rigid dorsal support comprising a single central column divided into two lateral branches passing over the shoulders of the user, without contacting the user or arms of the user; and wherein the two lateral branches are erected perpendicularly to the single central column and are projected forward on either side of the neck of the user.

19. The device of claim 18, wherein the two lateral branches are separated vertically from the shoulders of the user by 2 to 20 centimeters.

20. The device of claim 19, wherein the two lateral branches are separated vertically from the shoulders of the user by 5 to 15 centimeters.

21. The device of claim 18, wherein the two lateral branches are adjustable at least in height and in rotation with respect to the single central column.

22. The device of claim 18, wherein the single central column is adjustable in height at least at an upper portion of the single central column.

23. The device of claim 18, wherein the transfer member comprises two streamliners to manually extend or retract to change a length of the transfer member, each streamliner being disposed at least along the two lateral branches of the single central column.

24. The device of claim 23, wherein the streamliners are wires, cables, cords or straps.

25. The device of claim 23, wherein each lateral branch comprises a hollow tube and is passed through at least partially by a corresponding streamliner.

26. The device of claim 23, wherein each streamliner passes through a guide configured to reduce friction.

27. The device of claim 25, wherein the guide comprises an internal coating made of polytetrafluoroethylene locally covering the inside of the hollow tubes of the two lateral branches.

28. The device of claim 23, wherein said each streamliner is connected to a winder engaged with the single central column, the winder configured to automatically elongate or retract said each streamliner to change a length of said each streamliner.

29. The device of claim 23, wherein said each streamliner is provided, at a free end, with a handle of a sleeve type.

30. The device of claim 29, further comprising a manual brake close to at least one of the handles, the manual brake being engageable by the user to block or unblock a length of a corresponding streamliner.

31. The device of claim 18, wherein the single central column comprises a hinge pin in a zone connecting the single central column to the hip belt to follow an inclination of the back of the user with respect to lower limbs of the user.

32. The device of claim 18, wherein an elastic return element connects the hip belt to a lower portion of the single central column.

33. The device of claim 18, wherein the single central column comprises at least one back cushion.

34. The device of claim 18, further comprising shoulder straps to transport the device by the user.

35. The device of claim 18, further comprises elastic straps connecting the hip belt to lower limbs of the user.
